(19) United States
(12) Patent Application Publication
(10) Pub. No.: US 2012/0047540 A1
(43) Pub. Date: Feb. 23, 2012

(54) LODGING ENTERTAINMENT APPARATUS AND METHOD FOR USE OF SAME

(76) Inventors: Bill Fang, Plano, TX (US); Vanessa Ogle, Richardson, TX (US)

(21) Appl. No.: 13/216,117

(22) Filed: Aug. 23, 2011

Related U.S. Application Data
(60) Provisional application No. 61/376,206, filed on Aug. 23, 2010.

(51) Int. Cl. H04N 7/18

(52) U.S. Cl. 725/82

(57) ABSTRACT

A lodging entertainment apparatus and method for use of the same are disclosed. In one embodiment of the lodging entertainment apparatus, a memory is located within a housing and configured to store hospitality content which includes events, channel guide, and amenities relative the lodging establishment. An input is configured to receive an existing video signal that originates independently of the lodging entertainment apparatus and including content differing from hospitality content. An output is configured to independently transmit the hospitality content and the existing video signal. A user interface is configured to receive instructions from a user. A processor is located within the housing and communicatively coupled to the input, the output, the memory, and the user interface. The processor selectively provides the hospitality content in response to a power ON condition of the lodging entertainment apparatus.

### PRIORITY STATEMENT

This application filed in the names of Vanessa Ogle of Richardson, Tex. and Bill Fang of Plano, Tex. claims the benefit of priority from co-pending U.S. Provisional Patent Application No. 61/376,206, entitled “Lodging Entertainment Apparatus and Method for Use of Same” and filed on Aug. 23, 2010 in the names of Vanessa Ogle et al.; which is hereby incorporated by reference for all purposes.

### TECHNICAL FIELD OF THE INVENTION

This invention relates, in general, to entertainment systems and, in particular, to lodging entertainment systems providing content and including welcome channels for communicating with guests.

### BACKGROUND OF THE INVENTION

Lodging entertainment systems typically include a headend broadcast system which is located within the lodging facility and which is linked to guest terminals in the individual guest rooms by a cable distribution system, for example. A hotel welcome channel is provided by the lodging establishment to welcome guests and to communicate the hotel messaging when the television is initially turned ON. Attractive graphics and video furnished by the headend broadcast system detail service information about the lodging establishment and local attractions. There is a continuing need for improved lodging entertainment systems that offer greater efficiencies.

### SUMMARY OF THE INVENTION

It would be advantageous to achieve improved lodging entertainment systems that offer greater efficiencies. It would also be desirable to enable a electrical and computer-based solution that would be both efficient and cost effective. To better address one or more of these concerns, in one aspect of the invention, a lodging entertainment apparatus and method for use of the same are disclosed. In one implementation, a memory is located within a housing and configured to store hospitality content which includes events, channel guide, and amenities relative the lodging establishment.

An input is configured to receive an existing video signal that originates independently of the lodging entertainment apparatus and including content differing from hospitality content. An output is configured to independently transmit the hospitality content and the existing video signal. A user interface is configured to receive instructions from a user. A processor is located within the housing and communicatively coupled to the input, the output, the memory, and the user interface. The processor selectively provides the hospitality content in response to a power ON condition of the lodging entertainment apparatus. These and other aspects of the invention will be apparent from and elucidated with reference to the embodiment(s) described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram depicting one embodiment of a lodging entertainment system;

FIG. 2 is a schematic diagram depicting another embodiment of a lodging entertainment system;

FIG. 3 is a schematic diagram of one embodiment of a lodging entertainment apparatus, which forms a component of the lodging entertainment system;

FIG. 4 is a data flow diagram of one embodiment of multiple lodging entertainment apparatuses interacting with the lodging entertainment system; and

FIG. 5 is a flow chart depicting one embodiment of a method for delivering lodging entertainment.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

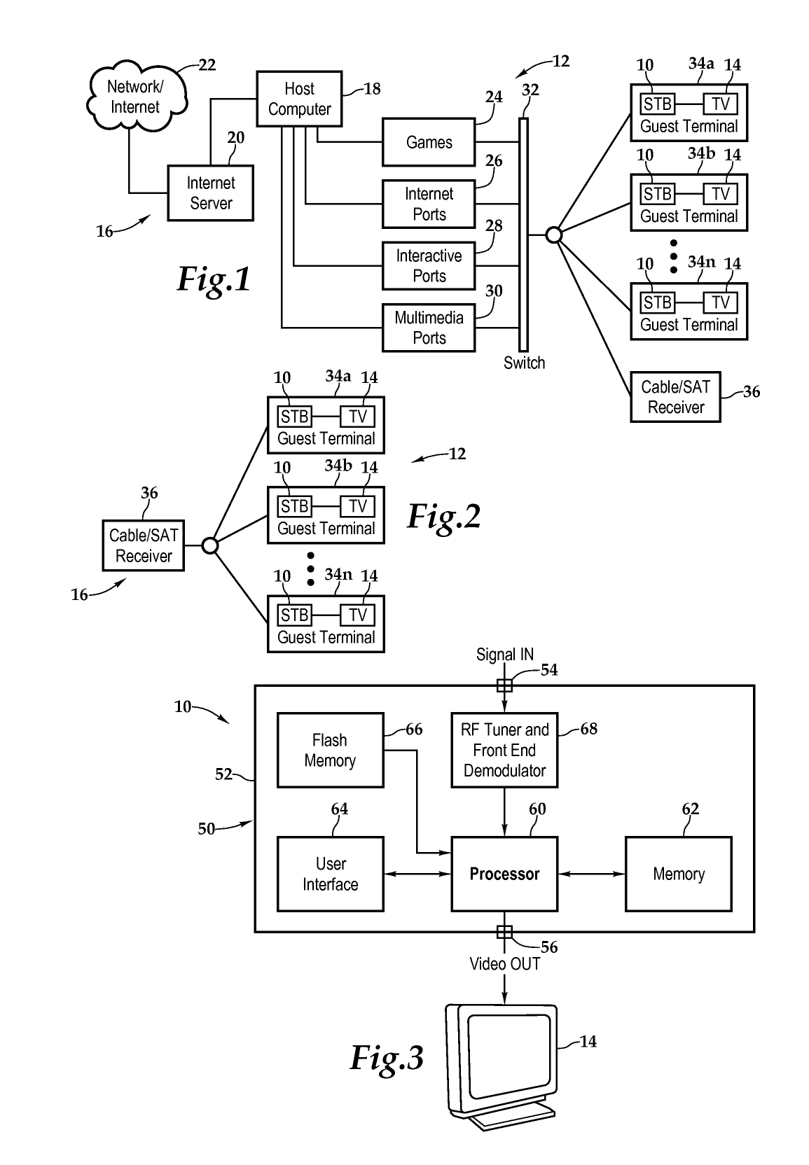

Referring to FIG. 1, a lodging entertainment apparatus 10 for a lodging establishment is schematically illustrated within a broader lodging entertainment system 12 including a television 14 for a hotel, for example, or other lodging establishment (e.g., hospital, hostel, or dormitory) which delivers television programming, Internet access, channel guide, and other interactive video services to individual guest rooms of a hotel or other lodging establishment.

Audio/video RF signals for channels of the cable television system are provided from a headend 16. The audio/video RF signals from the headend 16 may include off-air local television channels, direct broadcast satellite programming, interactive menus and interactive program guides, video-on-demand programming, interactive video games, channel guide, Internet services, and other interactive video and multi-media services. Based on the distribution depicted in FIG. 1, the headend 16 controls the operation of interactive menus and program guides, VOD movies, interactive games, Internet services, channel guide, and other interactive services.

The underlying distribution system may be a cable distribution system conventionally used in hotels and other lodging establishments. The transmission of both audio/video RF signals, as well as two-way data and digital communication signals between headend 16 and guest terminals 34a though 34n is provided. The headend 16 may include a host computer 18, Internet server 20 and network interface 22, game platform 24, Internet ports 26, digital content server providing content through multimedia ports 30, switch 32, cable/satellite receiver 36, and the video display terminal or television 14, for example. It should be appreciated that while a particular architecture for the headend 16 is depicted, other headend configurations are within the teachings presented herein. Each of the guest terminals 34a though 34n may include a television 14, remote control, game controller, and keyboard, for example. Each of the lodging entertainment apparatuses 10 interconnects these guest terminal devices with the headend 16.

FIG. 2 depicts another embodiment of the lodging entertainment system 12, wherein the underlying distribution system and guest terminals are supported by no headend or a minimal headend 16 that includes a cable/satellite receiver 36 connected to guest terminals 34a through 34n. As previously discussed, it should be appreciated that the lodging entertainment apparatus 10 and accompanying system 12 may be deployed in a variety of lodging configurations. By way of further example, the lodging entertainment apparatus may be utilized in a hybrid system having characteristics of both the systems illustrated in FIGS. 1 and 2.

Referring to FIG. 3, in one embodiment, the lodging entertainment apparatus 10 includes a housing 50 having multiple walls 52. Memory 62 is located within the housing 50 and configured to store hospitality content, which includes information relative to events, channel guide, and amenities. Multiple inputs traverse the walls of the housing to provide interfaces for the guest terminal devices. In particular, the input 54 is configured to receive an existing video signal which originates independently of the lodging entertainment apparatus and includes content differing from hospitality content.

Various outputs are similarly provided to furnish interfaces for the guest terminal devices. One of the outputs, output 56, traverses one of the walls of the housing 50 to transmit one of the hospitality content and the existing video signal to the television 14. A user interface 64, which may be a button or series of buttons, is configured to receive instructions from a user.

As shown, a processor 60 is located within the housing 50 and communicatively coupled to the input 54, the output 56, the memory 62, the user interface 64, flash memory 66, and RF turner and frontend demodulator 68. The processor 60 selectively provides the hospitality content residing in the memory 62 in response to a power ON condition of the lodging entertainment apparatus 10 or alternatively at the prompting of the user. For example, the user may request the hospitality content residing in the memory 62 by pressing a MENU button on the remote control. It should be appreciated that although a processor 60 is depicted, various combinations of micro-processors, graphics engines, MPEG decoders, and flash memory may be employed.

In operation, a hotel welcome channel or channels are used by the hotel to welcome guests and to communicate the hotel messaging when the guest room television is turned ON. The welcome channel may provide a screen that has visually attractive graphics and video, detailing service information about the hotel to the guest. As previously discussed, the traditional welcome channel architecture involves a broadcast TV channel that can deliver the programming to all rooms in the hotel. This requires broadcasting headend equipment at the hotel or an offsite location that is dedicated to feed the welcome channel signal to the hotel rooms.

With the teachings presented herein, the lodging entertainment apparatus 10 locally generates the welcome page having the hospitality content and channel guide. The lodging entertainment apparatus 10 therefore eliminates the need for a portion of the dedicated hotel headend equipment and, therefore, frees up cable TV channels for normal TV programs, as well as providing the flexibility to have customized welcome information for a particular guest or a particular room.

In one implementation, the information and content data required to create the welcome channel, channel guide, and hospitality content is downloaded to the lodging entertainment apparatuses throughout the lodging establishment prior to use. The data required to be downloaded includes video files, graphics, and screen layout parameters. The download can be done using available digital RF data channels, such as DOCSIS or COB, or a specially generated data broadcast channel using a QAM modulated data link. Alternatively, the data may be transmitted over an IP network or through a local media exchange such as a USB flash memory stick.

Once downloaded, the data that creates the hospitality content resides in the memory, which may include the memory 62 and/or flash memory 66, which may also be referred to as memory. Based on the hotel requirements, the lodging entertainment apparatus can then dynamically generate the hospitality content at any time, without requiring additional headend overhead, and will be available even when outages may occur with the local hotel TV service.

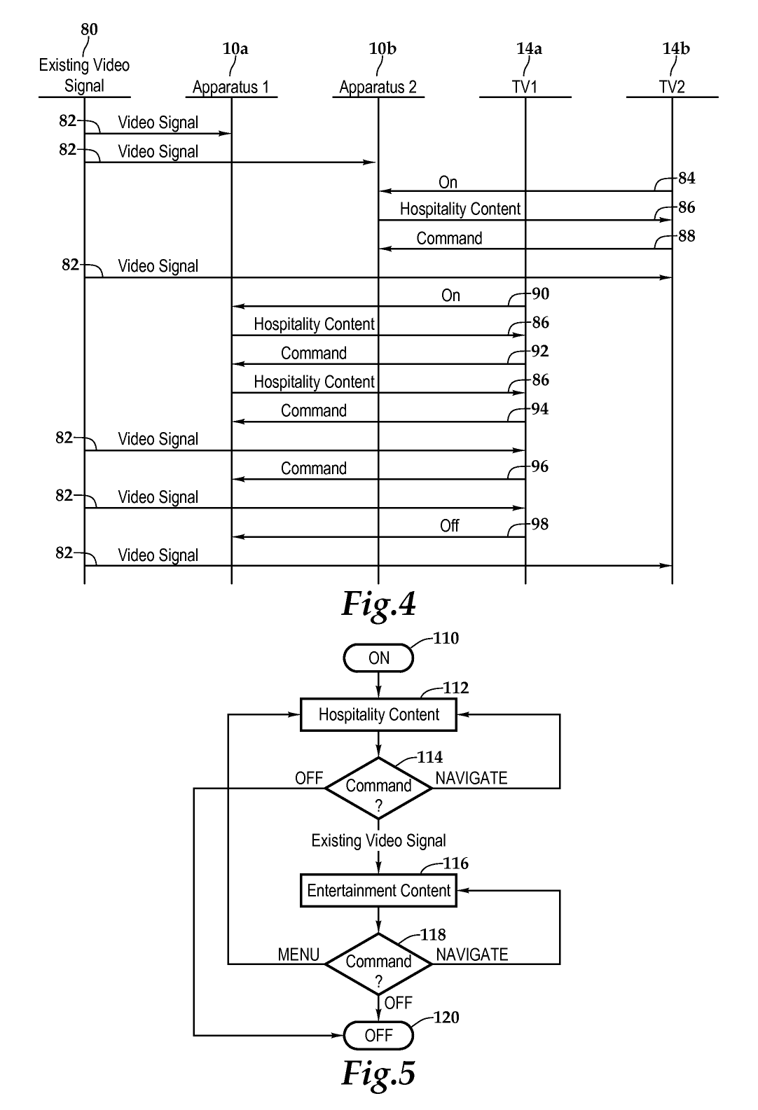

Referring to FIG. 4, one embodiment of multiple lodging entertainment apparatuses 10a and 10b interacting with the lodging entertainment system is depicted. Each of the lodging entertainment apparatuses 10a and 10b is associated with a respective television 14a and 14b. An existing video signal furnished by common headend components 80 is provided to each of the lodging entertainment apparatuses 10a and 10b as shown by video signal 82. A power ON signal is received from a user at television 14b and the ON signal 84 causes the lodging entertainment apparatus 10b to provide hospitality content signal 86 to the television 14b. As previously discussed, the hospitality content signal 86 is not generated from the existing video signal 82, rather the hospitality content signal is locally generated at the lodging entertainment apparatus 10b. Moreover, the generation and overhead of the hospitality content is not dependent nor does it interfere with the video signal 82. A command signal 88 received from the user indicates that the user desires to view content associated with the video signal 82. The apparatus 10b then selectively provides this content.

As shown by power on signal 90 and command signals 92, 94, 96, and power off signal 98, the provisioning of the hospitality content is locally associated with each lodging entertainment apparatus 10a and 10b, while the video signal 82 is provided from a common headend. That is, the lodging entertainment apparatuses provide hospitality content locally without taxing the common headend and without utilization of the existing video signal. In fact, the hospitality content may be provided regardless of the status or availability of the existing video signal. Moreover, the hospitality content at one lodging entertainment apparatus is provided independent of the provisioning of the hospitality content at another lodging entertainment apparatus.

Referring to FIG. 5, in one embodiment, the methodology includes providing multiple lodging entertainment apparatuses in units in the multi-unit environment, which, as previously discussed may be a hotel, hospital, hostel, multi-family residence or dormitory, for example. Each of the lodging entertainment apparatuses are configured to receive the existing video feed from the common headend and the hospitality content, which may include events and amenities relative the lodging establishment, is loaded in the local memory of each apparatus. the processor further comprises set-top box functionality. As previously discussed, the hospitality content may include a channel, multiple channels, a channel guide, or tourist-relevant information about the lodging establishment, for example.

With respect to the operation of a single lodging entertainment apparatus, at block 110, the user interface detects a power ON condition at the lodging entertainment apparatus and hospitality content, locally stored, is provided to the television at block 112. At decision block 114, the user may decide to continue to navigate the hospitality content, to view entertainment content provided by the existing video signal or turn the power OFF. Depending on the decision made, the methodology returns to block 112 for additional hospitality content, advances to block 116 to view entertainment content provided by the existing video signal, or advances to block 120, where the methodology concludes.

Returning to block 116, the existing video signal from the common headend is provided through the lodging entertainment apparatus to the television. The entertainment content may include television programming, Internet access, movies and other content discussed in FIGS. 1 and 2 provided by the headend. At decision block 118, the user may further navigate the options by selecting a command (e.g., change channel) to stay within the entertainment content provided by the headend by returning to block 116, return to the hospitality content (e.g., pressing the MENU button) at block 112, or advance to block 120 by pressing power OFF to end the user's interaction with the television.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A lodging entertainment apparatus for a lodging establishment, the lodging entertainment apparatus comprising:
a housing including a plurality of walls;
memory located within the housing, the memory configured to store hospitality content, the hospitality content including events and amenities relative the lodging establishment;
an input traversing one of the plurality of walls of the housing, the input configured to receive an existing video signal, the existing video signal originating independently of the lodging entertainment apparatus and including content differing from hospitality content;
an output traversing one of the plurality of walls of the housing, the output configured to transmit one of the hospitality content and the existing video signal;
a user interface configured to receive instructions from a user; and
a processor located within the housing, the processor communicatively coupled to the input, the output, the memory, and the user interface, the processor configured to selectively provide the hospitality content residing in the memory in response to a power ON condition of the lodging entertainment apparatus.

2. The lodging entertainment apparatus as recited in claim 1, wherein the processor further comprises set-top box functionality.

3. The lodging entertainment apparatus as recited in claim 1, wherein the hospitality content comprises a channel.

4. The lodging entertainment apparatus as recited in claim 1, wherein the hospitality content comprises a plurality of channels.

5. The lodging entertainment apparatus as recited in claim 1, wherein the hospitality content comprises a channel guide.

6. The lodging entertainment apparatus as recited in claim 1, wherein the hospitality content comprises tourist-relevant information about the lodging establishment.

7. The lodging entertainment apparatus as recited in claim 1, wherein the lodging entertainment apparatus is utilized in a multi-unit environment selected from the group consisting of hotels, hospitals, hostels, multi-family residences, and dormitories.

8. The lodging entertainment apparatus as recited in claim 1, wherein the processor selectively provides the hospitality content in response to a MENU condition of the lodging entertainment apparatus.

9. A lodging entertainment system for a lodging establishment, the lodging entertainment system comprising:
a plurality of lodging entertainment apparatuses, each lodging entertainment apparatus including:
a housing including a plurality of walls;
memory located within the housing, the memory configured to store hospitality content, the hospitality content including events and amenities relative the lodging establishment;
an input traversing one of the plurality of walls of the housing, the input configured to receive an existing video signal, the existing video signal originating independently of the lodging entertainment apparatus and including content differing from hospitality content;
an output traversing one of the plurality of walls of the housing, the output configured to transmit one of the hospitality content and the existing video signal;
a user interface configured to receive instructions from a user; and
a processor located within the housing, the processor communicatively coupled to the input, the output, the memory, and the user interface, the processor configured to selectively provide the hospitality content residing in the memory in response to a hospitality condition of the lodging entertainment apparatus;
each of the plurality of lodging entertainment apparatuses configured to receive the respective existing video feeds from a common headend; and
each of the plurality of lodging entertainment apparatuses configured to provide hospitality content locally without taxing the common headend.

10. The lodging entertainment system as recited in claim 9, wherein each of the processors further comprises set-top box functionality.

11. The lodging entertainment system as recited in claim 9, wherein the hospitality content comprises a channel.

12. The lodging entertainment system as recited in claim 9, wherein the hospitality content comprises a plurality of channels.

13. The lodging entertainment system as recited in claim 9, wherein the hospitality content comprises a channel guide.

14. The lodging entertainment system as recited in claim 9, wherein each of the plurality of lodging entertainment apparatuses is utilized in a multi-unit environment selected from the group consisting of hotels, hospitals, hostels, multi-family residences, and dormitories.

15. The lodging entertainment system as recited in claim 9, wherein the hospitality condition comprises a condition selected from the group consisting of a power ON condition and a MENU condition.

16. A method for providing lodging entertainment in a multi-unit environment having a common headend providing an existing video feed, the method comprising:
providing a plurality of lodging entertainment apparatuses in units in the multi-unit environment, each lodging entertainment apparatus including a housing having therein a processor communicatively coupled to an input configured to couple to the existing video feed, an output configured to couple to a television, a memory, and a user interface;
configuring each of the plurality of lodging entertainment apparatuses to receive the existing video feed from the common headend;
loading each of memories in the plurality of lodging entertainment apparatuses with hospitality content, the hospitality content including events and amenities relative the lodging establishment;
providing the existing video signal from the common headend to each of the plurality of lodging entertainment apparatuses, the existing video signal originating independently of each of plurality of the lodging entertainment apparatus and including content differing from hospitality content;
selectively providing, at each output of the plurality of lodging entertainment apparatuses, based on a local hospitality condition, the existing video feed and a hospitality content residing in the memory; and
determining the hospitality condition from information received by the user interface;
thereby each of the plurality of lodging entertainment apparatuses provides hospitality content locally without taxing the common headend and without utilization of the existing video signal.

17. The method as recited in claim 16, wherein determining the hospitality condition further comprises receiving information from the group consisting of a power ON condition and a MENU condition.

18. The method as recited in claim 16, further comprising providing at each output of the plurality of lodging entertainment apparatuses the hospitality content upon the existing video signal from the common headend being unavailable.

19. The method as recited in claim 16, wherein providing the plurality of lodging entertainment apparatuses in units in the multi-unit environment further comprises selecting the multi-unit environment from the group consisting of hotels, hospitals, hostels, multi-family residences, and dormitories.

20. A lodging entertainment apparatus for a lodging establishment, the lodging entertainment apparatus comprising:
a housing including a plurality of walls;
memory located within the housing, the memory configured to store hospitality content, the hospitality content including events and amenities relative the lodging establishment;
an input means for receiving an existing video signal, the existing video signal originating independently of the lodging entertainment apparatus and including content differing from hospitality content;
an output means for transmitting one of the hospitality content and the existing video signal;
a user interface configured to receive instructions from a user; and
a processor located within the housing, the processor communicatively coupled to the input means, the output means, the memory, and the user interface, the processor configured to selectively provide the hospitality content residing in the memory in response to a power ON condition of the lodging entertainment apparatus.

21. The lodging entertainment apparatus as recited in claim 1, wherein the lodging entertainment apparatus is utilized in a multi-unit environment selected from the group consisting of hotels, hospitals, hostels, multi-family residences, and dormitories.
